(19) United States
(12) Patent Application Publication
(10) Pub. No.: US 2015/0153580 A1
(43) Pub. Date: Jun. 4, 2015

(54) 3D LIQUID CRYSTAL DISPLAY APPARATUS AND CONTROL METHOD FOR THE SAME

(71) Applicant: SHENZHEN CHINA STAR OPTOELECTRONICS TECHNOLOGY CO., LTD., Shenzhen, Guangdong (CN)

(72) Inventor: Bin Fang, Shenzhen (CN)

(21) Appl. No.: 14/130,326

(22) PCT Filed: Dec. 6, 2013
(86) PCT No.: PCT/CN2013/088718

§ 371 Date: Dec. 31, 2013

(30) Foreign Application Priority Data
Nov. 29, 2013 (CN) 201310628940.0

(51) Int. Cl. G02B 27/22; G09G 5/10

(52) U.S. Cl. CPC G02B 27/2264; G02B 27/2228; G09G 5/10

(57) ABSTRACT

The present invention discloses a 3D liquid crystal display apparatus and control method thereof. An ideal light distribution is obtained by disposing a liquid crystal panel for controlling light transmission onto a backlight module within the 3D liquid crystal display apparatus. The present invention is capable of improving the problem of 3D cross-talk effect in an existing 3D liquid crystal display apparatus.

### BACKGROUND OF THE INVENTION

1. Field of the Invention

The present invention relates to a liquid crystal display apparatus and control method thereof, and more specifically to a three-dimensional (3D) liquid crystal display apparatus and control method thereof.

2. Description of the Prior Art

With the development of science and technology, users are pursing stereoscopic and more realistic video displays rather than high quality videos. Three-dimensional (3D) glasses are commonly used in 3D display technology. Shutter glasses 3D technology is commonly used in 3D glasses.

The features of shutter glasses 3D technology are that the glass for the right eye is disabled to be opaque when the glass for the left eye is enabled to be transparent, so that the audience can watch left eye images. Oppositely, when the glass for the right eye is enabled to be transparent, the glass for the left eye is disabled to be opaque, so that the audience can watch right eye images. In shutter glasses 3D technology, each of the 3D image data is theoretically considered to be an independent left-eye view or an independent right-eye view. When the image data are played, images at different viewing angles are accepted by the left and right eyes of a viewer and combined into 3D images with depth information in the viewer's brain. Thus, a stereo vision is produced.

If a video display apparatus which collaborates with shutter glasses is a liquid crystal display apparatus in the prior art, since a higher refresh rate (e.g., 120 Hz or 240 Hz) is generally required for the liquid crystal display apparatus, and therefore the liquid crystal display apparatus often includes a scanning backlight module, the higher refresh rate is achieved by the scanning backlight module.

Since the scanning backlight module often includes a light guide plate structure, light will be guided to other neighboring areas of the light guide plate structure when a light bar of a single area is lighted up. Such light guide phenomenon as described above leads to increase in the 3D cross-talk effect. Therefore, there is a need to provide a 3D liquid crystal display apparatus which can improve the problem of the 3D cross-talk effect, so as to overcome the disadvantage in the prior art.

### SUMMARY OF THE INVENTION

An object of the present invention is to provide a 3D liquid crystal display apparatus and control method thereof. An ideal light distribution is obtained by disposing a liquid crystal panel for controlling light transmission onto a backlight module within the 3D liquid crystal display apparatus. The present invention is capable of improving the problem of 3D cross-talk effect in an existing 3D liquid crystal display apparatus.

To achieve the above object, the present invention provides a 3D liquid crystal display apparatus that includes:

a backlight module;
a first panel including a first liquid crystal layer and a plurality of scanning lines for providing left eye images and right eye images, the first panel being disposed on the backlight module; and
a second panel including a second liquid crystal layer for allowing light produced by the backlight module to pass only through the area of the second panel corresponding to the scanning line which is being updated in the first panel, the second panel being disposed between the backlight module and the first panel or disposed on the first panel.

In one exemplary embodiment of the present invention, the backlight module provides a planar light source.

In one exemplary embodiment of the present invention, the backlight module is an edge-type backlight module.

In one exemplary embodiment of the present invention, the first panel includes a pair of substrates, and the pair of substrates each have a polarizing sheet.

In one exemplary embodiment of the present invention, the second panel has a polarizing sheet.

In one exemplary embodiment of the present invention, the area of the second panel is rectangular.

In one exemplary embodiment of the present invention, the first panel is a liquid crystal display panel,

In one exemplary embodiment of the present invention, the 3D liquid crystal display apparatus is applied to a shutter glasses 3D technology.

Furthermore, the present invention further provides a method for controlling a 3D liquid crystal display apparatus, the 3D liquid crystal display apparatus includes a first panel, a second panel, and a backlight module. The first panel includes a first liquid crystal layer and a plurality of scanning lines, and the first panel is disposed on the backlight module. The second panel includes a second liquid crystal layer, and the second panel is disposed between the backlight module and the first panel or disposed on the first panel. The method for controlling the 3D liquid crystal display apparatus includes the following steps of:

sequentially updating the scanning lines to display left eye images and right eye images onto the first panel; and
sequentially making areas of the second panel corresponding to the sequentially updated scanning lines in the first panel appear in a bright state.

In one exemplary embodiment of the present invention, the backlight module provides a planar light source.

In one exemplary embodiment of the present invention, the areas of the second panel are rectangular.

In one exemplary embodiment of the present invention, the first panel is a liquid crystal display panel.

In one exemplary embodiment of the present invention, the 3D liquid crystal display apparatus is applied to a shutter glasses 3D technology.

In one exemplary embodiment of the present invention, the bright state is obtained by applying a voltage to the second liquid crystal layer.

In one exemplary embodiment of the present invention, the bright state is obtained by turning off a voltage of the second liquid crystal layer.

The present invention has obvious advantages and beneficial effects over the prior art. The 3D liquid crystal display apparatus and control method thereof of the present invention according to the above technical scheme has at least the following advantages and beneficial effects, The ideal light distribution is obtained by disposing the liquid crystal panel for controlling light transmission onto the backlight module within the 3D liquid crystal display apparatus, and thus the problem of the 3D cross-talk effect in the existing 3D liquid crystal display apparatus is improved.

### BRIEF DESCRIPTION OF THE DRAWINGS

FIG. 1 is a schematic view of the structure of a 3D liquid crystal display apparatus according to one embodiment of the present invention;

FIG. 2 is a schematic view of the structure of a 3D liquid crystal display apparatus according to another embodiment of the present invention; and

FIG. 3 is an exploded perspective view of light passing through a second panel in a 3D liquid crystal display apparatus according to an embodiment of the present invention.

### DETAILED DESCRIPTION OF THE PREFERRED EMBODIMENTS

Various preferred embodiments are now described with reference to the accompanying drawings. In the following description, for purposes of explanation, numerous specific details are set forth in order to provide a thorough understanding of a 3D liquid crystal display apparatus and control method thereof, and its specific embodiment, structure, feature and functions.

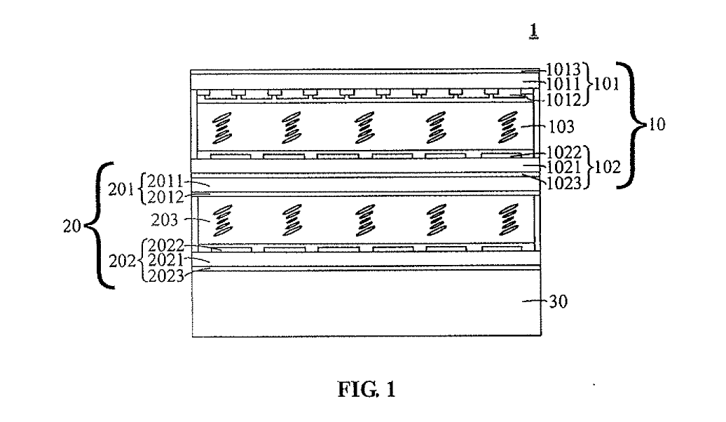

Please refer to FIG. 1, in which a schematic view of the structure of a 3D liquid crystal display apparatus 1 according to the first embodiment of the present invention is illustrated. The 3D liquid crystal display apparatus 1 includes a first panel 10, a second panel 20, and a backlight module 30. The second panel 20 is sandwiched between the first panel 10 and the backlight module 30. The 3D liquid crystal display apparatus 1 is applied to a shutter glasses 3D technology.

The first panel 10 includes a first substrate 101, a second substrate 102, and a first liquid crystal layer 103. The first liquid crystal layer 103 is sandwiched between the first substrate 101 and the second substrate 102. The first panel 10 is a liquid crystal display panel for providing left eye images and right eye images. The second panel 20 includes a third substrate 201, a fourth substrate 202, and a second liquid crystal layer 203. The second liquid crystal layer 203 is sandwiched between the third substrate 201 and the fourth substrate 202. The first liquid crystal layer 103 and the second liquid crystal layer 203 are respectively filled with a liquid crystal composition commonly used in the art. The second liquid crystal layer 203 can be filled with a twisted nematic (TN) liquid crystal composition or a super-twisted nematic (STN) liquid crystal composition. The backlight module 30 provides a planar light source. The backlight module 30 can be an edge-type backlight module.

The first substrate 101 can be a color filter substrate, which includes a first transparent substrate 1011, a color filter layer 1012, and a first polarizing sheet 1013. The color filter layer 1012 is disposed on the inner surface of the first transparent substrate 1011. The first polarizing sheet 1013 is disposed on the outer surface of the first transparent substrate 1011. The second substrate 102 can be a thin film transistor (TFT) array substrate, which includes a second transparent substrate 1021, a first TFT array layer 1022, and a second polarizing sheet 1023. The first TFT array layer 1022 is disposed on the inner surface of the second transparent substrate 1021. The second polarizing sheet 1023 is disposed on the outer surface of the second transparent substrate 1021. The first TFT array layer 1022 contains a plurality of scanning lines (not shown in the figure).

The third substrate 201 includes a third transparent substrate 2011 and a transparent electrode layer 2012. The transparent electrode layer 2012 is disposed on the inner surface of the third transparent substrate 2011. The fourth substrate 202 can be a thin film transistor (TFT) array substrate, which includes a fourth transparent substrate 2021, a second TFT array layer 2022, and a third polarizing sheet 2023. The second TFT array layer 2022 is disposed on the inner surface of the fourth transparent substrate 2021. The third polarizing sheet 2023 is disposed on the outer surface of the fourth transparent substrate 2021.

In another embodiment of the present invention, either the second transparent substrate 1021 or the third transparent substrate 2011 can be omitted, so as to reduce the thickness of the 3D liquid crystal display apparatus, according to the present invention.

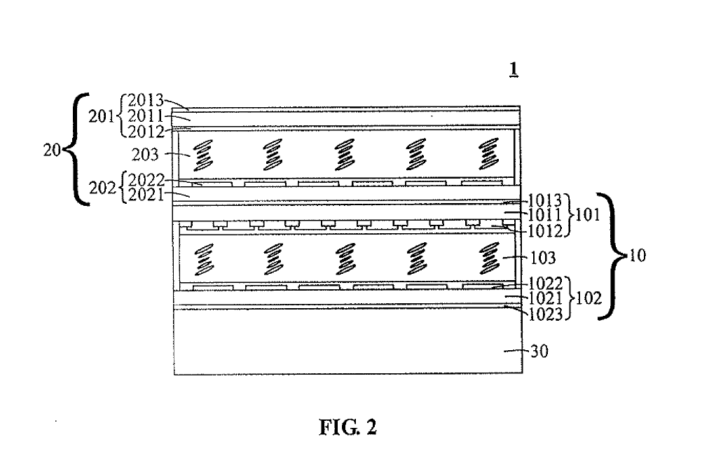

Please refer to FIG. 2, which is a schematic view of the structure of a 3D liquid crystal display apparatus 1 according to the second embodiment of the present invention. The 3D liquid crystal display apparatus 1 includes a first panel 10, a second panel 20, and a backlight module 30. The first panel 10 is sandwiched between the second panel 20 and the backlight module 30. The 3D liquid crystal display apparatus 1 is applied to a shutter glasses 3D technology.

The first panel 10 includes a first substrate 101, a second substrate 102, and a first liquid crystal layer 103. The first liquid crystal layer 103 is sandwiched between the first substrate 101 and the second substrate 102. The first panel 10 is a liquid crystal display panel for providing left eye images and right eye images. The second panel 20 includes a third substrate 201, a fourth substrate 202, and a second liquid crystal layer 203. The second liquid crystal layer 203 is sandwiched between the third substrate 201 and the fourth substrate 202. The first liquid crystal layer 103 and the second liquid crystal layer 203 are respectively filled with a liquid crystal composition commonly used in the art. The second liquid crystal layer 203 can be filled with a TN liquid crystal composition or a STN liquid crystal composition. The backlight module 30 provides a planar light source. The backlight module 30 can be an edge-type backlight module.

The first substrate 101 can be a color filter substrate, which includes a first transparent substrate 1011, a color filter layer 1012, and a first polarizing sheet 1013. The color filter layer 1012 is disposed on the inner surface of the first transparent substrate 1011. The first polarizing sheet 1013 is disposed on the outer surface of the first transparent substrate 1011. The second substrate 102 can be a thin film transistor (TFT) array substrate, which includes a second transparent substrate 1021, a first TFT array layer 1022, and a second polarizing sheet 1023. The first TFT array layer 1022 is disposed on the inner surface of the second transparent substrate 1021. The second polarizing sheet 1023 is disposed on the outer surface of the second transparent substrate 1021. The first TFT array layer 1022 contains a plurality of scanning lines (not shown in the figure).

The third substrate 201 includes a third transparent substrate 2011, a transparent electrode layer 2012, and a third polarizing sheet 2013. The transparent electrode layer 2012 is disposed on the inner surface of the third transparent substrate 2011. The third polarizing sheet 2013 is disposed on the outer surface of the third transparent substrate 2011. The fourth substrate 202 can be a thin film transistor (TFT) array substrate, which includes a fourth transparent substrate 2021 and a second TFT array layer 2022. The second TFT array layer 2022 is disposed on the inner surface of the fourth transparent substrate 2021.

In another embodiment of the present invention, either the first transparent substrate 1011 or the fourth transparent substrate 2021 can be omitted, so as to reduce the thickness of the 3D liquid crystal display apparatus, according to the present invention.

In the first embodiment and the second embodiment, the second panel 20 is used for allowing light produced by the backlight module 30 to pass only through the area of the second panel 20 corresponding to the scanning line which is being updated in the first panel 10. The area of the second panel 20 is rectangular, and the area of the second panel 20 appears in a bright state.

In accordance with the 3D liquid crystal display apparatus I as described above, the following specifically describes a method for controlling the 3D liquid crystal display apparatus of the present invention. The method for controlling the 3D liquid crystal display apparatus includes the following steps of:

1) sequentially updating the scanning lines to display left eye images and right eye images onto the first panel 10; and
2) sequentially making areas of the second panel 20 corresponding to the sequentially updated scanning lines in the first panel 10 appear in a bright state, wherein the bright state can be obtained by applying a voltage to the second liquid crystal layer 203, or by turning off a voltage of the second liquid crystal layer 203.

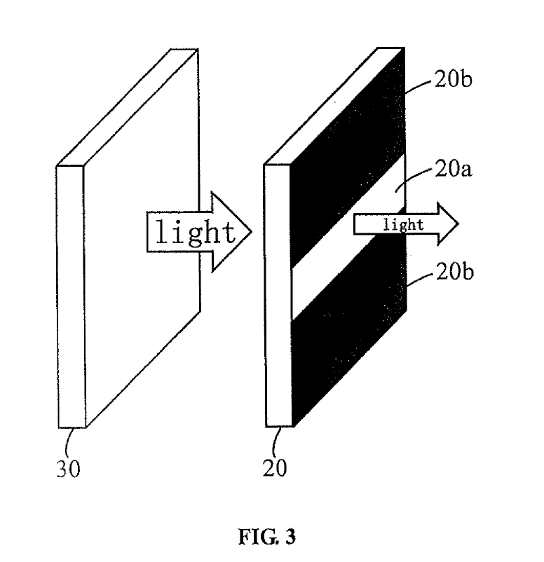

Then, please refer to FIG. 3, which is an exploded perspective view of light passing through a second panel 20 in a 3D liquid crystal display apparatus 1 according to an embodiment of the present invention. In the present embodiment, the backlight module 30 provides a planar light source. In FIG. 3, the area 20a, which appears in a bright state on the second panel 20, is aligned with the scanning line which is being updated in the first panel 10, while areas 20b, which appear in a dark state on the second panel 20, are aligned with the scanning lines which are not updated in the first panel 10. Herewith, the light produced by the backlight module 30 can only be passed through the area 20a which appears in a bright state of the second panel 20, rather than the areas 20b which appears in a dark state of the second panel 20. Therefore, from another point of view, a function of collaboration between the backlight module 30 and the second panel 20 of the present invention can be said to be the same as the function of the prior art scanning backlight module.

As mentioned above, in the 3D liquid crystal display apparatus and control method thereof of the present invention, an ideal light distribution is obtained by disposing a liquid crystal panel for controlling light transmission onto the backlight module within the 3D liquid crystal display apparatus, and thus the problem of the 3D cross-talk effect in an existing 3D liquid crystal display apparatus is improved.

The above description of the invention is intended to be illustrative and not limiting. Various changes or modifications in the embodiments described may occur to those skilled in the art. These can be achieved without departing from the spirit or scope of the invention.

What is claimed is:

1. A method for controlling a 3D liquid crystal display apparatus, the 3D liquid crystal display apparatus applied to a shutter glasses 3D technology comprising a first panel, a second panel, and an edge-type backlight module, the first panel comprising a first liquid crystal layer and a plurality of scanning lines, the first panel being disposed on the edge-type backlight module, the second panel comprising a second liquid crystal layer, the second panel being disposed between the edge-type backlight module and the first panel or disposed on the first panel, the method for controlling the 3D liquid crystal display apparatus comprising the following steps of:
sequentially updating the scanning lines to display left eye images and right eye images onto the first panel; and
sequentially making areas of the second panel corresponding to the sequentially updated scanning lines in the first panel appear in a bright state, the bright state being obtained by applying a voltage to the second liquid crystal layer, or by turning off a voltage of the second liquid crystal layer.

2. The method for controlling the 3D liquid crystal display apparatus of claim 1, wherein the areas of the second panel are rectangular.

3. The 3D liquid crystal display apparatus, comprising:
a backlight module;
a first panel comprising a first liquid crystal layer and a plurality of scanning lines for providing left eye images and right eye images, the first panel being disposed on the backlight module; and
a second panel comprising a second liquid crystal layer for allowing light produced by the backlight module to pass only through the area of the second panel corresponding to the scanning line which is being updated in the first panel, the second panel being disposed between the backlight module and the first panel or disposed on the first panel.

4. The 3D liquid crystal display apparatus of claim 3, wherein the backlight module provides a planar light source.

5. The 3D liquid crystal display apparatus of claim 3, wherein the backlight module is an edge-type backlight module.

6. The 3D liquid crystal display apparatus of claim 3, wherein the first panel comprises a pair of substrates, and the pair of substrates each have a polarizing sheet.

7. The 3D liquid crystal display apparatus of claim 3, wherein the second panel has a polarizing sheet.

8. The 3D liquid crystal display apparatus of claim 3, wherein the area of the second panel is rectangular.

9. The 3D liquid crystal display apparatus of claim 3, wherein the 3D liquid crystal display apparatus is applied to a shutter glasses 3D technology.

10. A method for controlling a 3D liquid crystal display apparatus, the 3D liquid crystal display apparatus comprising a first panel, a second panel, and a backlight module, the first panel comprising a first liquid crystal layer and a plurality of scanning lines, the first panel being disposed on the backlight module, the second panel comprising a second liquid crystal layer, the second panel being disposed between the backlight module and the first panel or disposed on the first panel, the method for controlling the 3D liquid crystal display apparatus comprising the following steps of:
sequentially updating the scanning lines to display left eye images and right eye images onto the first panel; and
sequentially making areas of the second panel corresponding to the sequentially updated scanning lines in the first panel appear in a bright state.

11. The method for controlling the 3D liquid crystal display apparatus of claim 10, wherein the backlight module provides a planar light source.

12. The method for controlling the 3D liquid crystal display apparatus of claim 10, wherein the areas of the second panel are rectangular,

13. The method for controlling the 3D liquid crystal display apparatus of claim 10, wherein the 3D liquid crystal display apparatus is applied to a shutter glasses 3D technology.

14. The method for controlling the 3D liquid crystal display apparatus of claim 10, wherein the bright state is obtained by applying a voltage to the second liquid crystal layer.

15. The method for controlling the 3D liquid crystal display apparatus of claim 10, wherein the bright state is obtained by turning off a voltage of the second liquid crystal layer.
